(19) United States
(12) Patent Application Publication
(10) Pub. No.: US 2004/0143675 A1
(43) Pub. Date: Jul. 22, 2004

(54) Resynchronizing drifted data streams with a minimum of noticeable artifacts

(76) Inventor: Andreas Matthias Aust, Princeton, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/345,858

(22) Filed: Jan. 16, 2003

(51) Int. Cl. G06F 15/16

(52) U.S. Cl. 709/236; 709/231

(57) ABSTRACT

A system and method for synchronization of data streams are disclosed. A classification unit receives information about frames of data and provides a rating for each frame that indicates a probability for introducing noticeable artifacts by modifying the frame. A resynchronization unit receives the rating associated with the frames and resynchronizes the data streams based on a reference in accordance with the rating.

### FIELD OF THE INVENTION

The present invention generally relates to data stream synchronization and, more particularly, to a method and system, which resynchronizes data streams received from a network and reduces the noticeable artifacts that are introduced during resynchronization.

### BACKGROUND OF THE INVENTION

Many multimedia player and video conferencing systems currently available on the market utilize packet-based networks, with applications providing audio and/or video based services running on non-real-time operations systems. Different media streams (e.g., the audio stream and the video stream of a video conference) are often transmitted separately and usually have a fixed temporal relation. Heavy network load conditions, heavy central processing unit (CPU) loads, or different clocks for sending and receiving devices result in a loss of quality of service that requires a system to drop frames, samples, or introduce frames/samples at the receiving side to resynchronize the audio and video stream. However, conventional resynchronization schemes introduce noticeable artifacts into the data streams.

Considering, for example, an Internet Protocol (IP) (see RFC0791 Internet Control Message Protocol, 1981) based video conferencing system that employs Personal Computers (PCs) as end devices, a video and an audio stream may drift at the receiving side due to network jitter or slightly different sampling rates at sending and receiving sides. For the video part, the display frame rate is easily adjusted. The audio part causes more problems however since the sampling rate is much higher than the frame rate. The audio samples are usually passed block-wise to a sound device that has a fixed sampling rate. So to adjust playback time, a sampling rate conversion is usually too complex, and thus a few samples are added (padding) or removed from the blocks. This usually causes noticeable artifacts in the replay.

Resynchronization is usually done by detecting silent periods and introducing or deleting samples accordingly. A silent period is typically used as the moment to resynchronize the audio stream because it is very unlikely to lose or destroy important information. But there are cases where a resynchronization has to be performed, and no silent period exists in the signal.

### SUMMARY OF THE INVENTION

A system for synchronization of data streams is disclosed. A classification unit receives information about frames of data and provides a rating for each frame, which indicates a probability for introducing noticeable artifacts by modifying the frame. A resynchronization unit receives the rating associated with the frames and resynchronizes the data streams based on a reference in accordance with the rating.

A method for resynchronizing data streams includes classifying frames of data to provide a rating for each frame, which indicates a probability that a modification to the frame may be made to reduce noticeable artifacts. The data streams are resynchronized by employing the rating associated with the frames to determine a best time for adding and deleting frames to resynchronize the data streams in accordance with a reference.

### BRIEF DESCRIPTION OF THE DRAWINGS

The advantages, nature, and various additional features of the invention will appear more fully upon consideration of the illustrative embodiments in connection with accompanying drawings wherein:

FIG. 1 is a block/flow diagram showing a system/method for synchronizing media or data streams to reduce or eliminate noticeable artifacts in accordance with one embodiment of the present invention; and

FIG. 2 is a timing diagram that illustratively shows synchronization differences between a sending side and a receiving side for two media streams in accordance with one embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention provides a method and system that reduces the noticeable artifacts that are introduced during resynchronization of multiple data streams. Classification of frames of multimedia data is performed to indicate how far a possible adjustment between the data streams can be made without resulting in noticeable artifacts. “Noticeable artifacts” includes any perceivable difference in synchronization between data streams. An example may include lip movements of a video out of synch with the audio portion. Other examples of noticeable artifacts may include blank frames, too many consecutive still frames in a video, unwanted audio noise, or random macroblocks composition in a displayed frame. The present invention preferably uses a decoding and receiving unit to obtain information for classification, and then resynchronizes one or more data streams based on the classifications. In this way, frames or blocks (data) are added or subtracted from at least one data stream at the best available location or time whether or not silent pauses are available for resynchronization.

It is to be understood that the present invention is described in terms of a video conferencing system; however, the present invention is much broader and may include any digital multimedia delivery system having a plurality of data streams to render the multimedia content. In addition, the present invention is applicable to any network system and the data streams may be transferred by telephone, cable, over the airwaves, computer networks, satellite networks, Internet, or any other media.

It also should be understood that the elements shown in the FIGS. may be implemented in various forms of hardware, software or combinations thereof.

Preferably, these elements are implemented in a combination of hardware and software on one or more appropriately programmed general-purpose devices, which may include a processor, memory and input/output interfaces.

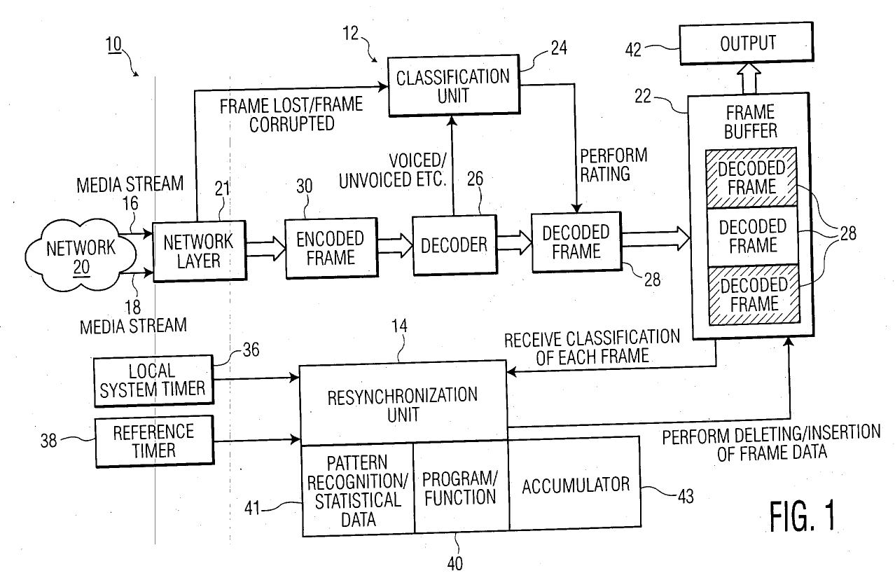

Referring now in specific detail to the drawings in which reference numerals identify similar or identical elements throughout the several views, and initially to FIG. 1, a system 10 that permits identification of a best time or times to perform the resynchronization, is shown. System 10 is capable of synchronizing one or more media streams to another media stream or to a clock signal. For example, a video stream (intermedia synchronization) is synchronized with an audio stream to be lip synchronous, or a media stream may be synchronized to a time base of a receiving system (intramedia synchronization). The difference between these approaches is that in one case; the audio stream may be used as a relative time base, while in the other case; the system time/clock is referred to.

System 10 preferably includes a receiver 12 having a resynchronization unit 14 coupled to receiver 12. In one embodiment, receiver 12 receives two media streams, e.g., an audio stream 16 and a video stream 18. Streams 16 and 18 are to be synchronized for a function as playback or recording. Audio stream 16 may include frames that have been produced by an encoder (not shown) at a sending side. The frames may have duration of, for example, from about 10 ms to about 30 ms, although other durations are also contemplated. Additionally, the type of video frames processed by the system may be, for example, MPEG-2 compatible I, B, and P frames, but other frame types may be used. The frames are preferably sent in packets through a network 20. At a receiving side (receiver 12), a number of frames are pre-fetched or buffered by a frame buffer 22 to be able to equalize network and processing delays.

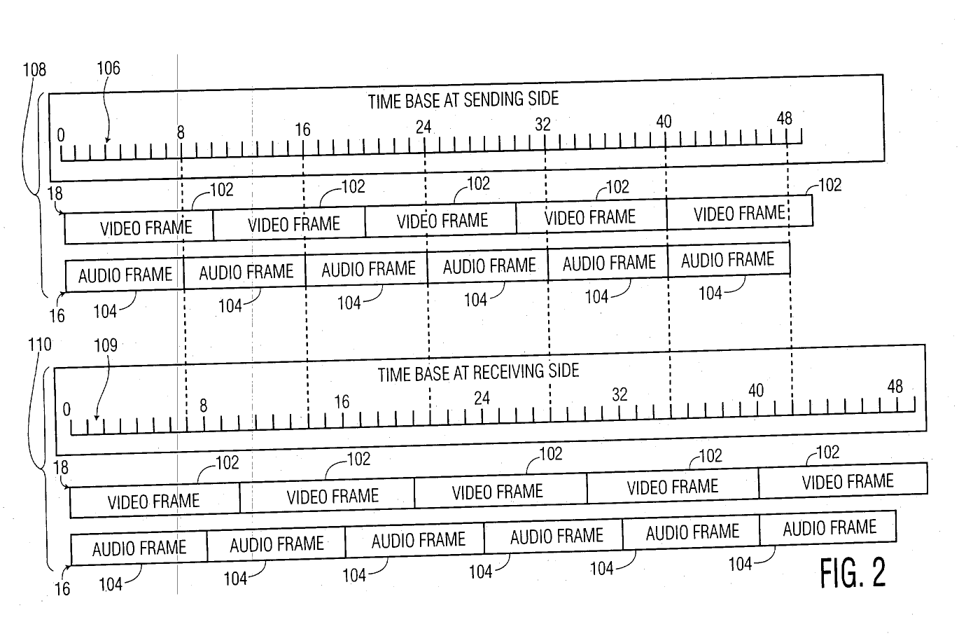

FIG. 2 shows a timing diagram showing frames 102 of video stream 18 and frames 104 of audio stream 16, as compared to a time base 106 at a sending side 108 and a time base 109 at a receiving side 110. Different clock rates at the sending and receiving ends can cause drift between streams 16 and 18. In this example, where the receiver clock is running slower than the sender clock, an error may occur where the buffer level at the receiving side would overflow. This possible error condition is detectable and fixed by dropping classified audio frame samples thereby allowing video frames to be played back faster or dropped. Hence, allowing for streams 16 and 18 to be resynchronized at optimal times. In accordance with the principles of the present invention, one skilled in the art would apply the teachings of this invention to remedy of types of problems requiring the resynchronization between at least two media streams.

Referring again to FIG. 1, the incoming frames are classified by a classification unit 24 at the receiving side with a number that specifies how far a modification of that frame for resynchronization purposes will influence the audio quality. This number or rating is assigned to frames by classification unit 24 and can be performed based on information at the network layer 21 where, e.g., information like “frame corrupt” or “frame lost” is available. Additionally, the rating of the frames can be performed according to a set of parameters that is available/generated during a decoding process performed by a decoder 26. Common speech encoders like ITU G. 723, GSM AMR, MPEG-4 CELP, MPEG-4 HVXC, etc. may be employed and provide some of the following illustrative parameters: Voiced signal (vowels), Unvoiced signal (consonants), Voice activity (i.e., silence or voice), Signal energy, etc.

Depending on built-in error concealment of decoder 26 the following illustrative ratings may be employed, as listed in TABLE 1:

TABLE 1

| RATING | TYPE OF FRAME |
|---|---|
| 0 | Corrupt frame |
| 1 | Lost frame |
| 2 | Silent Frame |
| 3 | Unvoiced frame |
| 4 | Voiced frame |

Other rating systems, parameters and values may be employed in accordance with the present invention. The rating of the present invention indicates to resynchronization unit 14 which frame of the currently buffered frames 28 permits the introduction or removal of samples with the least impact on the subjective sound quality (e.g., 0 means least impact, 4 means maximum impact). A corrupt frame and a lost frame may introduce noticeable noise, but inserting or removing samples of that frame may not cause additional artifacts. As noted above, silent periods are more likely used for resynchronization. Unvoiced frames usually have less energy than voiced frames so modifications in unvoiced frames will be less noticeable. If the decoder comes with a mature mechanism to recover errors from corrupted or lost frames, the rating may be different.

Encoded frames 30 enter decoder for decoding. Information about each frame is input to classification unit 24 from network layer 21 and from decoder 26. Classification unit 24 outputs a rating and associates the rating with each decoded frame 28. Decoded frames 28 are stored in frame buffer 22 with the rating. The rating of each frame is input to resynchronization unit 14 to analyze a best opportunity to resynchronize the media or data streams 16 and 18. Resynchronization unit 14 may employ a local system timer 36 or a reference timer 38 to resynchronize streams 16 and 18. Timer 36 may include a system's clock signal or any other timing reference, while reference timer 38 may be based on the timing of a reference stream that may include either of stream 16 or stream 18, for example.

Once input to resynchronization unit 14, each frame is analyzed relative to nearby frames to determine the best opportunity to delete or add frames/data to the stream. Resynchronization unit 14 may include a program or function 40 which polls nearby frames or maintains an accumulated rating count to estimate a relative position or time to resynchronize the data streams. For example, corrupted frames may be removed from a video stream to advance the stream relative to the audio stream depending on the discrepancy in synchronization between the streams. Likewise, video frames may be added by duplication to the stream to slow the stream relative to the audio stream. Multiple frames may be simultaneously added or removed from one or more streams to provide resynchronization. Frame rates of either stream may be adjusted to provide resynchronization as well, based on the needs of system 10.

Program 40 may employ statistical data 41 or other criteria in addition to frame ratings to select the appropriate frames to add or subtract. Statistical data may include such things as, for example, permitting only one frame deletion or addition per a number of cycles based on a number of frames of a given rating type. In another example, certain patterns of frame ratings may result in undesirable artifacts occurring. Resynchronization unit 14 and function 40 can be programmed to determine these patterns and be programmed to resynchronize the data streams in a way that reduces these artifacts. This may be based on user experience, based on feedback from an output 42, or from data developed outside of system 10 related to the operation of other resynchronization systems.

It is to be understood that the present invention may be applied to other media streams including music, data, video data or the like. In addition, while the FIGS. show two data streams being synchronized, the present invention is applicable to synchronizing a greater number of data streams. Additionally, the data streams may encompass audio or video streams generated by different encoders and are encoded at varying rates. For example, there may be two different video streams that represent the same audio/video source at different sampling rates. The resynchronization scheme of the present invention is able to take into account these variances and utilize frames from one source over frames from another source, if synchronization problems exist. The invention may also consider using frames from a stream generated from one encoder (for example. RealAudio) over a stream of a second encoder (for example, Windows Media Player), for resynchronization data streams in accordance with the principles of the present invention.

The data streams may be sent over network 20. Network 20 may include a cable modem network, a telephone (wired or wireless) network, a satellite network, a local area network, the Internet, or any other network capable of transmitting multiple data streams. Additionally, the data streams need not be received over a network, but may be received directly between transmitter-receiver device pairs. These devices may include walkie-talkies, telephones, handheld/laptop computers, personal computers, or other devices capable of receiving multiple data streams.

The origin, (as with the other attributes described above) of a data stream may also be taken into account in terms of resynchronizing data streams. For example, a video stream originating from an Internet source may result in too many resynchronization attempts, causing too many frames to be dropped. An alternative source, such as from a telephone, or an alternative data stream, would be used to replace the stream resulting in the playback errors. In this embodiment, accumulator 43 (for example, a register or memory block) in resynchronization unit 14 would keep a record of the types of frame errors of a current media stream resynchronized by using the rankings listed in a table (e.g., Table 1) as values to be added to a stored record in accumulator 43. After the record stored in the accumulator exceeds a threshold value, the resynchronization unit 14 would request an alternative media stream (e.g., from a different source, type of media stream of a specific encoder, or a media stream from a network capable of transmitting multiple streams) to replace the current media stream. System 10 would then utilize frames from the alternative media stream, to reduce the need for having to resynchronizing two or more media streams. Accumulator 43 is reset after the alternative media stream is used.

Although described in terms of a receiver device, the present invention may also be employed in a similar manner at the transmitting/sending side of the network or in between the transmitting and receiving locations of the system.

Having described preferred embodiments for resynchronizing drifted data streams with a minimum noticeable artifacts (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims.

What is claimed is:

1. A system for synchronization of data streams, comprising:
a classification unit which receives information about data representing a plurality of frames and provides a rating for at least one frame from the plurality of frames indicating a probability for introducing noticeable artifacts by modifying the frame; and
a resynchronization unit which receives the rating associated with the frame and resynchronizes the data streams based on a reference in accordance with the rating.

2. The system as recited in claim 1, wherein the reference includes at least one of: a local timer and a data stream.

3. The system as recited in claim 1, further comprising a decoder that decodes the received plurality of frames wherein the decoder provides input to the classification unit for determining the rating.

4. The system as recited in claim 3, wherein the information the decoder provides about an acoustic frame includes at least one of: a silent frame, an unvoiced frame, and a voiced frame.

5. The system as recited in claim 4, wherein the data streams are received from a network layer and the network layer provides information to the classification unit to indicate if a frame is lost or corrupted.

6. The system as recited in claim 5, further comprising a frame buffer that stores the plurality of frames and the rating associated with the plurality of frames for input to the resynchronization unit.

7. The system as recited in claim 6, wherein the resynchronization unit includes a program that determines a rating pattern, and resynchronizes the data streams according to the rating pattern.

8. The system as recited in claim 7, wherein the program includes statistical data to determine how resynchronization is implemented.

9 The system as recited in claim 8, wherein upon reaching a threshold value of resynchronizations, the resynchronization unit utilizes a second plurality of frames from an alternative data stream.

10. The system as recited in claim 1, wherein the rating for the frame comprises information related to at least one of: a source of the frame and a encoder used to generate the frame.

11. A method for resynchronizing data streams, comprising the steps of:
classifying data presenting a plurality of frames to provide a rating for at least one frame from the plurality of frames indicating a likelihood for introducing noticeable artifacts by modifying the frame; and
resynchronizing the data streams by employing the rating associated with the frame to determine a best time for adding and deleting data to resynchronize the data streams in accordance with a reference.

12. The method as recited in claim 11, wherein the reference includes a local timer and a data stream.

13. The method as recited in claim 11, further comprising the step of decoding the plurality of frames to provide input for classifying the plurality of frames to determine the rating.

14. The method as recited in claim 13, wherein the step of decoding includes decoding data representing an acoustic data stream to provide information about the plurality of frames which includes at least one of: a silent frame, an unvoiced frame, and a voiced frame.

15. The method as recited in claim 11, wherein the data streams are received from a network layer and further comprising the step of providing information for classification of the frame from the plurality of frames, by the network layer which indicates if a frame is lost or corrupted.

16. The method as recited in claim 11, further comprising the step of buffering frames in a frame buffer to store frames and the rating associated with the frames for input for the resynchronizing step.

17. The method as recited in claim 11, further comprising the steps of determining a rating pattern and resynchronizing the data streams according to the rating pattern.

18. The method as recited in claim 17, wherein upon reaching a threshold value of resynchronizations, the resynchronization unit utilizes frames from an alternative data stream.

19. The method as recited in claim 18, wherein the rating of the frame comprises information related to at least one of: a source of the frame and a encoder used to generate the frame.

20. A system for the synchronization of data streams, comprising:
means for classifying which receives information about frames of data and provides a rating for each frame which indicates a probability for introducing noticeable artifacts by modifying the frame; and
means for resynchronization which receives the rating associated with the frames and resynchronizes the data streams based on a reference in accordance with the rating.
